(19) United States
(12) Patent Application Publication
(10) Pub. No.: US 2023/0262313 A1
(43) Pub. Date: Aug. 17, 2023

(54) CAMERA MODULE

(71) Applicant: AAC Optics (Nanning) Co., Ltd., Nanning City (CN)

(72) Inventors: Wen Guo, Shenzhen (CN); Gao Yu, Shenzhen (CN)

(21) Appl. No.: 17/837,014

(22) Filed: Jun. 9, 2022

(30) Foreign Application Priority Data
Feb. 15, 2022 (CN) 202220304904.3

(51) Int. Cl. H04N 5/225

(52) U.S. Cl. CPC H04N 5/2257; H04N 5/2254; H04N 5/2253

(57) ABSTRACT

The present disclosure provides a camera module, comprising a base, a casing covering on the base and enclosing an accommodation space with the base, a support frame suspended in the accommodation space; a lens holder suspended in the support frame and configured to mount a lens, a circuit board covering on a side of the base away from the support frame and enclosing an accommodating cavity with the base, and a photosensitive chip arranged in the accommodating cavity and fixed on the circuit board; wherein the camera module further comprises electronic components fixed on an inner wall of the casing, and the casing is provided with pins electrically connecting the electronic components and the circuit board. Compared with the related art, the camera module of the present disclosure expands a circuit layout space of the circuit board indirectly, facilitates a line layout and meets electrical performance requirements.

### TECHNICAL FIELD

The present disclosure relates to the technical field of optical imaging, in particular to a camera module.

### BACKGROUND

With the development of camera technologies, camera modules are widely adopted in various camera devices. The combination products of camera modules and various portable electronic devices (such as mobile phones, cameras and computers are favored by consumers.

A camera module in the related art includes a base, a casing covering on the base and enclosing an accommodation space with the base, a lens holder suspended in the support frame and configured to mount a lens, a circuit board covering on a side of the base away from the support frame and enclosing an accommodating cavity with the base, and a photosensitive chip arranged in the accommodating cavity and fixed on the circuit board.

However, as a size of the camera module continues to evolve towards miniaturization, a wiring space of the circuit board is limited, and it is more and more difficult to arrange the circuit to meet an electrical performance requirement. In the related art, the increase of components due to the integration of electronic components on circuit boards and miniaturization are contradictory.

Therefore, it is necessary to provide an improved camera module to solve the above-mentioned problems.

### SUMMARY

An object of the present disclosure is to provide a camera module.

In order to achieve the above-mentioned object, the present disclosure provides a camera module, comprising a base, a casing covering on the base and enclosing an accommodation space with the base, a support frame suspended in the accommodation space; a lens holder suspended in the support frame and configured to mount a lens, a circuit board covering on a side of the base away from the support frame and enclosing an accommodating cavity with the base, and a photosensitive chip arranged in the accommodating cavity and fixed on the circuit board; wherein the camera module further comprises electronic components fixed on an inner wall of the casing, and the casing is provided with pins electrically connecting the electronic components and the circuit board.

As an improvement, the pins are formed by laser engraving in the casing.

As an improvement, the pins are conductive terminals fixed on the casing.

As an improvement, the pins are embedded in the casing.

As an improvement, the casing is fixed on a side of the base away from the circuit board, and the base is provided with avoidance holes for avoiding the pins.

As an improvement, the electronic components comprise at least one of memory chips.

As an improvement, the circuit board and the pins are connected by soldering.

Compared with the related art, in the camera module in the present disclosure, the electronic components are fixed on the inner wall of the casing, and the pins electrically connecting the electronic components and the circuit board are arranged on the casing to avoid that the electronic components are directly integrated on the circuit board, thereby expanding a circuit layout space of the circuit board indirectly, facilitating a line layout and meeting electrical performance requirements.

### BRIEF DESCRIPTION OF THE DRAWINGS

In order to describe the technical solutions in the embodiments of the present disclosure more clearly, accompanying drawings required to be used in the descriptions of the embodiments will be briefly introduced below. Obviously, the drawings in the illustration below are merely some embodiments of the present disclosure. Those ordinarily skilled in the art also can acquire other drawings according to the provided drawings without doing creative work.

FIG. 1 is a schematic structural diagram of a camera module according to the present disclosure.

### DETAILED DESCRIPTION OF THE EMBODIMENTS

The technical solutions in the embodiments of the present disclosure will be described clearly and completely below with reference to the drawings in the embodiments of the present disclosure. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

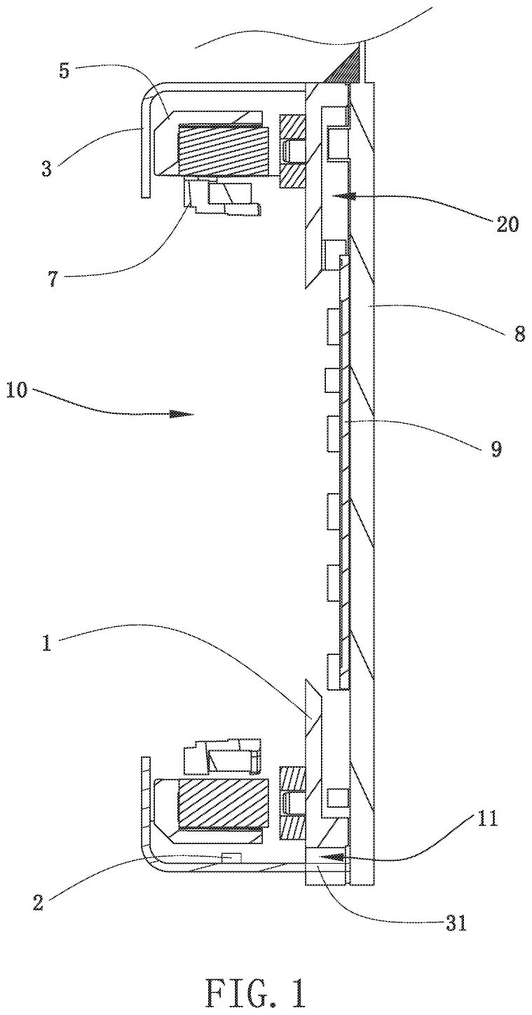

Referring to FIGS. 1, the present disclosure provides a camera module including a base 1, a casing 3 covering the base 1 and enclosing an accommodation space 10 with the base 1, a support frame 5 suspended in the accommodating space 10, a lens holder 7 suspended in the support frame 5 and configured to mount a lens, a circuit board 8 covering on a side of the base 1 away from the support frame 5 and enclosing an accommodating cavity 20 with the base 1, a circuit board 8 covering on the side of the base 1 away from the support frame 5 and enclosing an accommodating cavity 20 with the base 1, and a photosensitive chip 9 arranged in the accommodating cavity 20 and fixed on the circuit board 8. The camera module further includes electronic components fixed on an inner wall of the casing 32. The casing 3 is provided with pins 31 electrically connecting the electronic components 2 and the circuit board 8.

The electronic component 2 includes at least one of memory chips.

In some embodiments, the pins 31 may be formed by laser engraving in the casing 3.

In some embodiments, the pins 31 are conductive terminals fixed on the casing 3. Further optionally, the pins 31 are embedded on the casing 3.

In this embodiment, the casing 3 is fixed on a side of the base 1 away from the circuit board 8, and the base 1 is provided with avoidance holes 11 for avoiding the pins 31. It can be understood that, in other embodiments, the casing 3 may also be fixed on a side wall of the base 1. Accordingly, the pins 31 are electrically connected to the circuit board 8 through the side of the circuit board 8.

In this embodiment, the circuit board 8 and the pins 31 are connected by soldering.

Compared with the related art, in the camera module in the present disclosure, the electronic components are fixed on the inner wall of the casing, and the pins electrically connecting the electronic components and the circuit board are arranged on the casing to avoid that the electronic components are directly integrated on the circuit board, thereby expanding a circuit layout space of the circuit board indirectly, facilitating a line layout and meeting electrical performance requirements.

The embodiments of the present disclosure are described above only. It should be noted that those of ordinary skill in the art can further make improvements without departing from the concept of the present disclosure. These improvements shall all fall within the protection scope of the present disclosure.

What is claimed is:

1. A camera module, comprising
a base;
a casing covering on the base and enclosing an accommodation space with the base;
a support frame suspended in the accommodation space;
a lens holder suspended in the support frame and configured to mount a lens;
a circuit board covering on a side of the base away from the support frame and enclosing an accommodating cavity with the base; and
a photosensitive chip arranged in the accommodating cavity and fixed on the circuit board;
wherein the camera module further comprises electronic components fixed on an inner wall of the casing, and the casing is provided with pins electrically connecting the electronic components and the circuit board.

2. The camera module of claim 1, wherein the pins are formed by laser engraving in the casing.

3. The camera module of claim 1, wherein the pins are conductive terminals fixed on the casing.

4. The camera module of claim 3, wherein the pins are embedded in the casing.

5. The camera module of claim 1, wherein the casing is fixed on a side of the base away from the circuit board, and the base is provided with avoidance holes for avoiding the pins.

6. The camera module of claim 1, wherein the electronic components comprise at least one of memory chips.

7. The camera module of claim 1, wherein the circuit board and the pins are connected by soldering.
